(19) United States
(12) Patent Application Publication
(10) Pub. No.: US 2005/0117355 A1
(43) Pub. Date: Jun. 2, 2005

(54) Lamp shade

(76) Inventor: Kevin Hsu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/714,991

(22) Filed: Nov. 17, 2003

(51) Int. Cl. F21V 1/06; F21V 11/00; F21S 8/08

(52) U.S. Cl. 362/414

(57) ABSTRACT

A lamp shade includes a shade having two opposite sides separated from each other, and a fastening device mounted on the shade for combining the two opposite sides of the shade together. Thus, the lamp shade can be folded when not in use, so as to reduce the volume of the lamp shade, thereby facilitating package, storage and transportation of the lamp shade, and thereby decreasing the costs of transportation.

### BACKGROUND OF THE INVENTION

1. Field of the Invention

The present invention relates to a lamp shade, and more particularly to a lamp shade that can be folded when not in use, so as to reduce the volume of the lamp shade, thereby facilitating package, storage and transportation of the lamp shade, and thereby decreasing the costs of transportation.

2. Description of the Related Art

A conventional lamp shade 1 in accordance with the prior art shown in FIG. 6 comprises an upper ring 11, a lower ring 12, and a plurality of ribs 13 mounted between the upper ring 11 and the lower ring 12. The upper ring 11 has a mounting rack 111 for mounting a lamp, such as a table lamp.

However, the ribs 13 are fixed between the upper ring 11 and the lower ring 12 by soldering, so that the conventional lamp shade 1 has a fixed volume and cannot be folded, thereby causing inconvenience in package, storage and transportation of the conventional lamp shade 1, and thereby increasing the costs of package and transportation.

### SUMMARY OF THE INVENTION

The primary objective of the present invention is to provide a lamp shade that can be folded when not in use, so as to reduce the volume of the lamp shade, thereby facilitating package, storage and transportation of the lamp shade, and thereby decreasing the costs of transportation.

Another objective of the present invention is to provide a lamp shade that can be assembled and disassembled easily and conveniently, thereby facilitating the user assembling and disassembling the lamp shade.

In accordance with the present invention, there is provided a lamp shade, comprising:
a shade having two opposite sides separated from each other; and
a fastening device mounted on the shade for combining the two opposite sides of the shade together.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a lamp shade in accordance with the preferred embodiment of the present invention;

FIG. 2 is a plan view of a shade of the lamp shade as shown in FIG. 1;

FIG. 3 is a folded view of the shade of the lamp shade as shown in FIG. 2;

FIG. 4 is a schematic plan assembly view showing the lamp shade being mounted on a table lamp;

FIG. 5 is a folded view of a shade of a lamp shade in accordance with another embodiment of the present invention; and

FIG. 6 is a perspective view of a conventional lamp shade in accordance with the prior art.

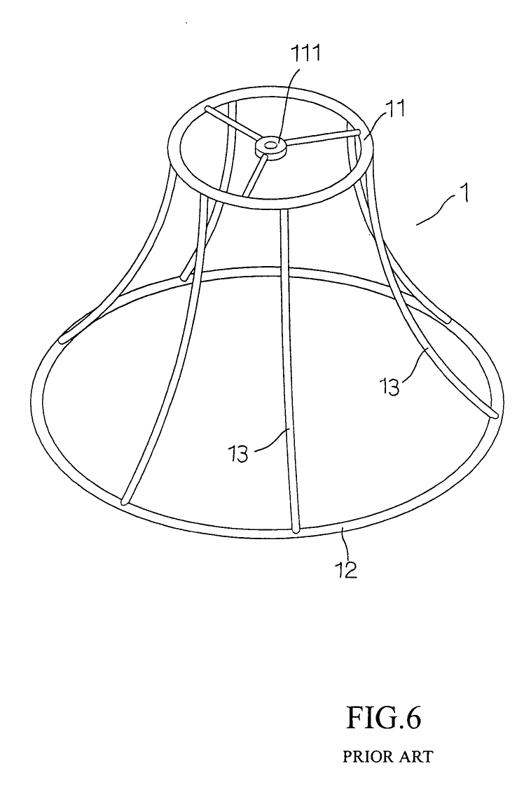

### DETAILED DESCRIPTION OF THE INVENTION

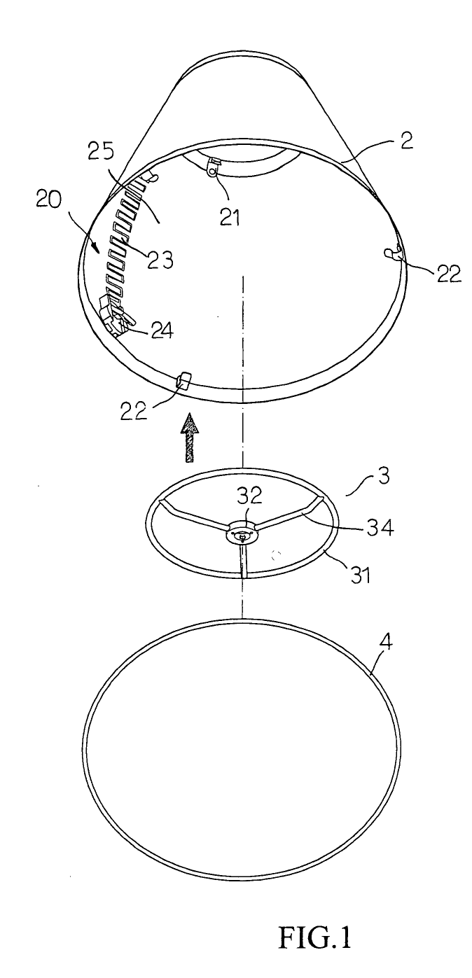

Referring to the drawings and initially to FIGS. 1-3, a lamp shade in accordance with the preferred embodiment of the present invention comprises a shade 2, a fastening device 20, an upper ring 3, and a lower ring 4.

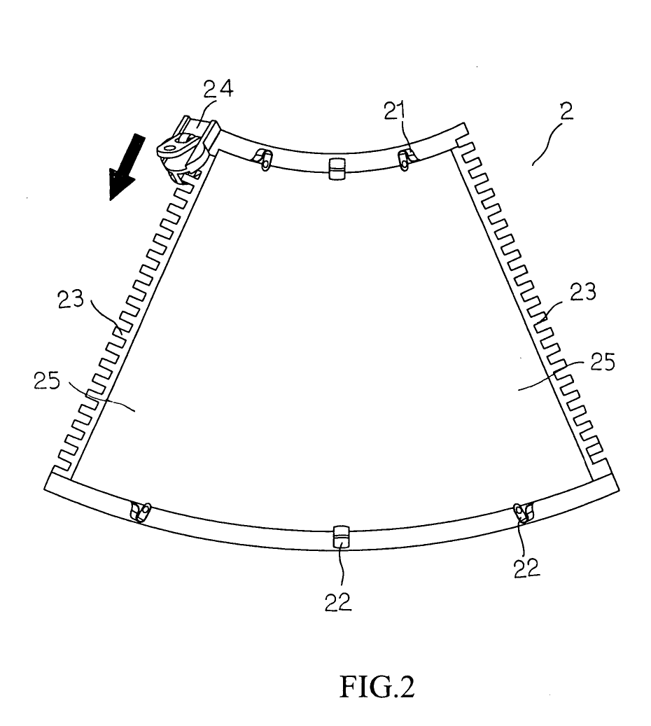

The shade 2 is foldable and has a planar shape when being expanded as shown in FIG. 2. The shade 2 has two opposite sides 25 separated from each other. The shade 2 has a first end formed with a plurality of first elastic locking plates 21 and a second end formed with a plurality of second elastic locking plates 22.

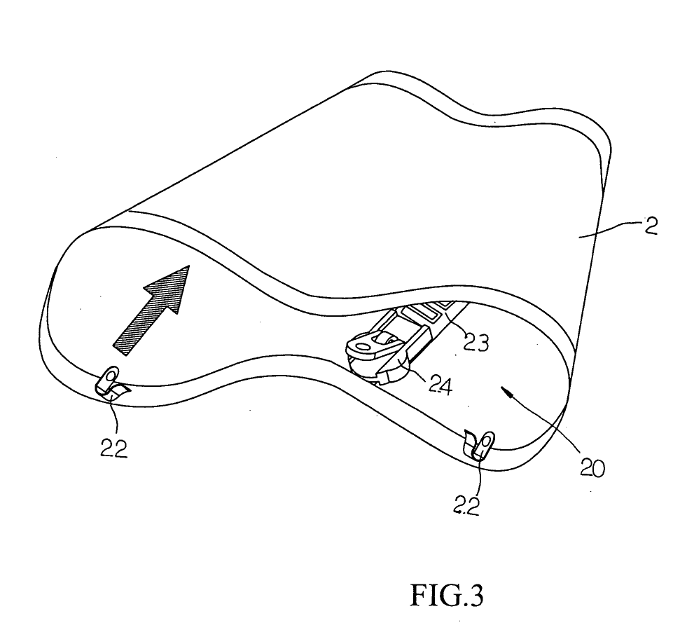

The fastening device 20 is mounted on the shade 2 for combining the two opposite sides 25 of the shade 2 together. The fastening device 20 includes two chains 23 each mounted on a respective one of the two opposite sides 25 of the shade 2, and a slide 24 slidably mounted on either one of the two chains 23 to combine the two chains 23 together, so that the two opposite sides 25 of the shade 2 are combined together, thereby forming a loop-shaped shade 2 as shown in FIG. 3.

The upper ring 3 is mounted on the first end of the shade 2 and has a rim 31 locked by the first elastic locking plates 21 of the shade 2, and a central portion formed with support portion 32 supported by a plurality of spiders 34.

The lower ring 4 is mounted on the second end of the shade 2 and is locked by the second elastic locking plates 22 of the shade 2.

In assembly, referring to FIGS. 1-4, the two chains 23 are combined together by the slide 24, so that the two opposite sides 25 of the shade 2 are combined together, thereby forming a loop-shaped shade 2 as shown in FIG. 3. Then, the upper ring 3 is mounted on the first end of the shade 2 with its rim 31 being locked by the first elastic locking plates 21 of the shade 2. Then, the lower ring 4 is mounted on the second end of the shade 2 and is locked by the second elastic locking plates 22 of the shade 2, thereby forming the expanded lamp shade.

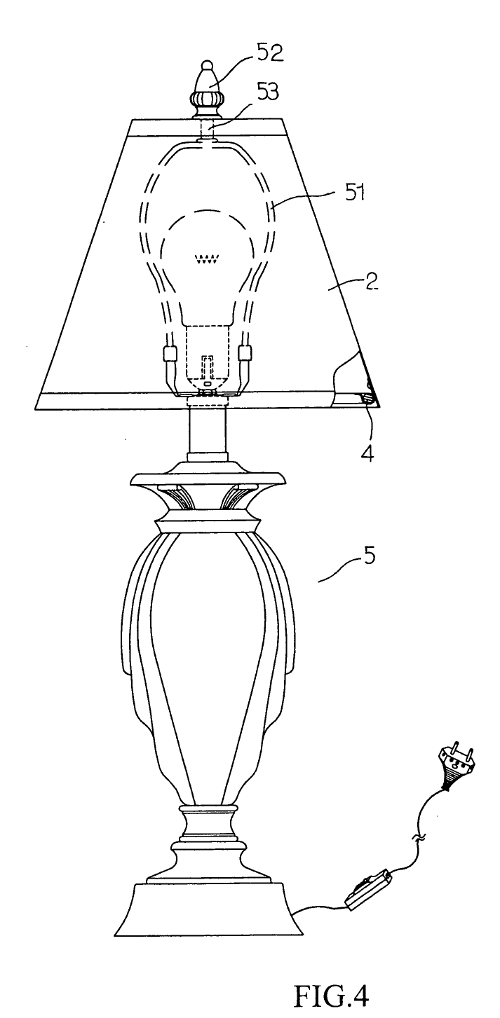

As shown in FIGS. 1 and 4, the expanded lamp shade is mounted on a table lamp 5. The table lamp 5 includes a harp 51 mounted in the shade 2 and rested on the bottom of the support portion 32 of the upper ring 3, a threaded rod 53 mounted on the harp 51 and extended through the support portion 32 of the upper ring 3, and a decorative nut 52 screwed on the threaded rod 53 and rested on the top of the support portion 32 of the upper ring 3, so that the expanded lamp shade is mounted on the table lamp 5.

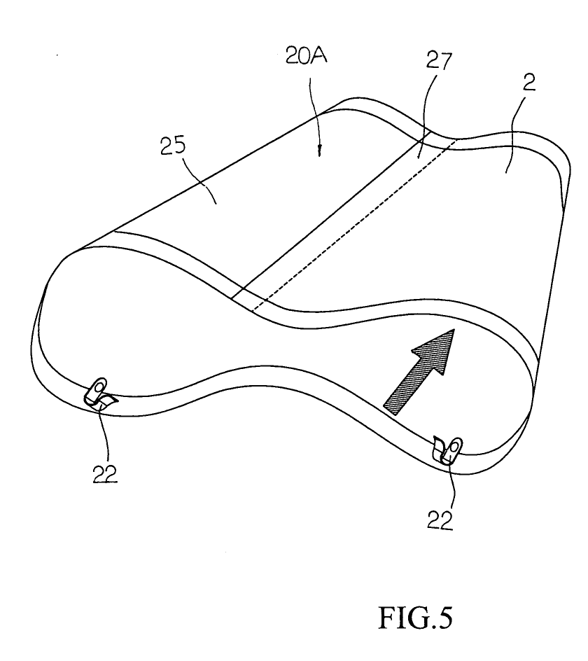

Referring to FIG. 5, the fastening device 20A includes two bonding straps 27 each mounted on a respective one of the two opposite sides 25 of the shade 2. Each of the bonding straps 27 is a loop-shaped or hook-shaped strap, so that the bonding straps 27 are combined together. Thus, the bonding straps 27 are combined together, so that the two opposite sides 25 of the shade 2 are combined together, thereby forming a loop-shaped shade 2 as shown in FIG. 5.

Accordingly, the lamp shade is assembled and disassembled easily and conveniently, thereby facilitating the user assembling and disassembling the lamp shade. In addition, the lamp shade can be folded when not in use, so as to reduce the volume of the lamp shade, thereby facilitating package, storage and transportation of the lamp shade, and thereby decreasing the costs of transportation.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp shade, comprising:
a shade having two opposite sides separated from each other; and
a fastening device mounted on the shade for combining the two opposite sides of the shade together.

2. The lamp shade in accordance with claim 1, wherein the shade is foldable.

3. The lamp shade in accordance with claim 2, wherein the shade has a loop shape when being folded.

4. The lamp shade in accordance with claim 1, wherein the shade has a planar shape when being expanded.

5. The lamp shade in accordance with claim 1, wherein the fastening device includes two chains each mounted on a respective one of the two opposite sides of the shade, and a slide slidably mounted on either one of the two chains to combine the two chains together, so that the two opposite sides of the shade are combined together, thereby forming a loop-shaped shade.

6. The lamp shade in accordance with claim 1, wherein the fastening device includes two bonding straps each mounted on a respective one of the two opposite sides of the shade, and the bonding straps are combined together, so that the two opposite sides of the shade are combined together, thereby forming a loop-shaped shade.

7. The lamp shade in accordance with claim 1, wherein the shade has a first end formed with a plurality of first elastic locking plates and a second end formed with a plurality of second elastic locking plates, and the lamp shade further comprises an upper ring mounted on the first end of the shade and having a rim locked by the first elastic locking plates of the shade, and a lower ring mounted on the second end of the shade and locked by the second elastic locking plates of the shade.
